(19) United States
(12) Patent Application Publication
(10) Pub. No.: US 2004/0224068 A1
(43) Pub. Date: Nov. 11, 2004

(54) High moisture, high protein, high fiber soy-based pasta without carbohydrates from grains or tubers

(76) Inventor: Paul K. Lee, Arcadia, CA (US)

Correspondence Address: W. Thomas Timmons, The White House on Turtle Creek, 2401 Turtle Creek Boulevard, Dallas, TX, 75219-4760, US

(21) Appl. No.: 10/611,054

(22) Filed: Jun. 30, 2003

Related U.S. Application Data
(60) Provisional application No. 60/467,966, filed on May 5, 2003.

(51) Int. Cl. A23L 1/00

(52) U.S. Cl. 426/557

(57) ABSTRACT

A high moisture content pasta high in soy protein and fiber without carbohydrate from grains or tubers. The main ingredients in this pasta are processed soy products. The high moisture content and special production process allow the pasta to be formed into different shapes such as sheets, various diameter/thickness of spaghetti, linguine, and tubes as well as pillows and bars with filling, or other forms.

### BACKGROUND OF THE INVENTION

1. Field of the Invention

This invention relates generally to a high protein food, specifically a high moisture, high fiber, soy-based pasta without carbohydrate from grains or tubers. The pasta is rich in amino acids, lecithin, and other nutrients and has a texture similar to traditional pasta.

2. Description of Related Art

Protein is the vital component of human body development. Babies need protein to develop muscles, blood cells, bone, neurons, and hair; adults need protein to repair and regenerate cells. Without water, human body consists of 50% protein.

Consumption of sufficient protein in daily diet is very important in maintaining a healthy body. Traditionally, the main source of protein in human diet is meat products such as pork, beef, lamb, and chicken. While these meat products are rich in protein, they are also high in fat and cholesterol. Consumption of excessive fat and cholesterol not only results in obesity, it is the main cause of coronary heart disease, high blood pressure, and heart attack.

Grains such as wheat and rice have long been a major part of human diet. On average, the carbohydrate content in grains range between 60%˜70%. Processed grains such as refined rice contain even higher carbohydrate percentage, reaching 90%.

Most of the carbohydrates in grains exist in the form of water soluble starch which is very easily absorbed by human body. The digestive rate of this type of carbohydrate in human body is as high as 98%. While every gram of carbohydrate transforms into 4 kcal (16.7 kJ) of calorie, diets based on grains often result in over intake of carbohydrate, which leads to excessive calorie intake and lead to weight management problems.

Although carbohydrate is the quickest source of human energy, we eat much more of it, by far, than our body needs. The combination of carbohydrate with animal fat has become the major cause of obesity and health problems.

People wish to be healthy or to loss weight need to pay special attention to their intake of animal fat, cholesterol, and carbohydrate. Reducing the consumption of meat can decrease the intake of fat and cholesterol but this diet will also limit protein intake; reducing the consumption of grain products such as rice, pasta, bread . . . etc. can decrease the intake of carbohydrate but often results in unsatisfied feeling after meals and lead to cravings for more food.

Thus, the development of a high protein, tasty, and filling food that does not contain animal fat, cholesterol, and carbohydrate from grains or tubers is a valuable contribution to human diet.

Various products have been developed to meet the above needs. Most of the current high protein pastas provide solutions by adding soy products such as soy flour or isolated soy protein into wheat semolina, wheat flour, other grain flour, or starch derived from tubers or grains to produce high soy protein pasta. The three main purposes of the current method are as follow:

1) Addition of soy products can raise the protein content.

2) Without the gelling function of starch from grains or tubers, soy flour cannot be coagulated to form different shapes.

3) Pastas with starch from grains or tubers provide a favorable texture that is satisfying while masticating. Thus, it is difficult to eliminate carbohydrate from starch in pasta.

The above three purposes restrain each other. To raise the protein content in pasta, the content of flour (thus starch) from grains or tubers needs to be reduced. Yet, reducing the starch content of grains or tubers sacrifices the texture of the pasta. To reach the same texture as traditional pasta, the starch content needs to be increased and the addition of protein is reduced. Thus, although replacing part of flour with soy flour enriches the protein content of the pasta and helps reduce meat fat and cholesterol intake in human diet, it does not resolve the problem of excess carbohydrate intake in current human diet.

This invention breaks away from the tradition of using grain flour or tuber flour as coagulation agent. It does not contain carbohydrate from grains or tubers but still preserves similar texture as traditional pasta. The main ingredient in this invention, not accounting water or water substitute, contains more than 90% of soy flour or concentrate. Soy is one of the best sources of protein besides meat. In a pound of soy, the protein content in soy is approximately 2.3 times the protein content in a pound of lean pork meat and 2 times the protein content in a pound of lean beef.

Soy proteins are complete proteins and include all the essential amino acids necessary for human needs, including at least 8 essential amino acids that cannot be generated by human body and must be consumed from food.

The major fat content in soy is unsaturated fatty acid. Different from animal fat, which mainly consists of saturated fat, unsaturated fatty acid can reduce the deposit of cholesterol on the arterial walls.

The carbohydrate content in soy consist very little water soluble starch and thus does not lead to weight gain. Several studies have shown that soy (protein) may help promote a healthy digestive tract and reduce colon cancer incidence.

Soy is rich in lecithin. Studies had demonstrated that lecithin has many benefits to human health such as: anti-aging; enhance brain and cells development, help delaying brain aging, enhance good memory, prevent Alzheimer's disease; prevent fatty liver; cardiovascular protective through lowering LDL-cholesterol and raising HDL-cholesterol, increase potential in dissolving deposited cholesterol on the arterial walls, thus may help in reversing atherosclerosis; increase the excretion of blood sugar and help stimulate insulin secretion, improve cellular metabolism and thus is a good food supplement for the diabetics; prevent gallstones formation; lower high blood pressures; help to dispose toxic wastes from the body.

Soy is also rich in dietary fiber which is beneficial in balancing blood sugar level, lowering blood fat content, prevent constipation, and prevent various cancers.

There are two types of dietary fibers, insoluble dietary fiber (IDF) and soluble dietary fiber (SDF). IDF is commonly found in wheat bran, corn bran, whole grain, breads, cereals, and vegetables such as cabbage, carrots, and brussel sprouts.

SDF is most commonly found in fruits such as apples, bananas, citrus, seaweed, mushrooms, oats, barley, and legumes.

IDF increases fecal weight, promotes bowel movements and thus relieves constipation. It also helps dispose toxin wastes and increases the skin metabolism, thus improves blood circulation and keeping skin young.

SDF expands to 10˜15 times in volume after dissolved in water and forms a gel like substance. Because of its water-holding capacity, after one consumes SDF, it absorbs water and increases the bulk of the intestines' contents, giving one the feeling of fullness and thus reduce food intake. Also, SDF helps delay glucose absorption, prevent sudden rise in blood sugar level. It also chelates with cholesterol, helps dispose cholesterol from human body and lowers blood fat content, beneficial to prevention of high blood pressure, heart attack, and atherosclerosis.

Soy dietary fiber is approximately half IDF and half SDF, providing the benefit of both SDF and IDF. This invention is high in soy fiber and contributes greatly to human health.

Because food products high in fiber content often have a less desirable texture, humans like to remove fiber from food, such as refining grains to form refined rice or white flour and result in high carbohydrate content in these food products.

This invention is a soy-based pasta that is high in protein and fiber without carbohydrate from grains or tubers.

Soy products are not as tasty as grain or tuber products and are very difficult to shape because soy does not have the gelling function of the starch in grains or tubers.

To replace starch, this invention includes thickeners such as guar gum to increase the viscidity of the material. Because thickeners such as guar gum also has gelling function, the thickening function and gelling function of the thickener allow this invention to provide a texture similar to grain and tuber products.

This invention also includes sodium alginate as gelling agent. Sodium alginate's gelling and thickening function intensify the binding of soy powder or soy milk with water, further improves the texture. Combining gelling agents such as sodium alginate with firming agents solidifies the evenly and tightly bonded soy powder, water, soy milk, and additives mixture, allows the mixture to be shaped into string, sheets, and various pasta shapes. This method allows the pasta to be formed without falling apart even without starch from grains or tubers.

### SUMMARY OF THE INVENTION

This invention is a high moisture, soy-based pasta that is high in protein and fiber without carbohydrate from grains or tubers. This pasta can be formed into various shapes such as strings, sheets, and other shapes. This pasta can be steamed, boiled, stir fried, pan seared, or deep fried and will not fall apart during the cooking process. This pasta also can easily be seasoned into various flavored pasta without adding fat and sugar.

This invention is different from traditional pasta that can be formed into various desired shapes without carbohydrates from grains or tubers and still maintain a favorable texture.

This invention contains complete amino acids, including at least 8 essential amino acids that human bodies cannot produce and must consume from food sources. The dietary fiber content of this invention consists of balanced IDF and SDF. This invention is most beneficial to people who wish to loss weight through reduction of fat and carbohydrate intake but wish to consume sufficient protein and satisfy cravings for food. This invention also helps improve cellular metabolism, enhance brain and cells development, enhance good memory, and prevent Alzheimer's disease. It also has anti-aging/food based cosmetics effect, helps prevent diabetes, gallstones formation, arteriosclerosis, high blood pressure, heart attack, constipation, and various cancers.

These and other objects, advantages and features of this invention will be apparent from the following description, wherein is shown a preferred embodiment of the invention.

### DESCRIPTION OF THE PREFERRED EMBODIMENT

This invention is a high protein, high fiber, and high moisture pasta without carbohydrates from grains or tubers.

The main ingredients are: 1) processed soy material 2) thickeners 3) gelling agents 4) water 5) firming agent 6) soy dietary fiber.

The production process is abbreviated as follow:

Mix together ingredients 1 to 4, inject firming agent into the mixture prior to extruding the mixture through dies to solidify the mixture into desired shapes.

1) Processed soy material can be soy protein isolate, soy protein concentrate, soy protein (soy flour full-fat, soy flour defatted), or soy milk.

When processed soy material is soy protein isolate, the soy protein isolate content is 30% of the final weight; when the processed soy material is soy protein concentrate, the soy protein concentrate content is 35% of the final weight; when the processed soy material is soy protein (soy flour full-fat or soy flour defatted), the soy protein content is 40% of the final weight. The content of processed soy material can be increased or decreased to create harder or softer texture.

Soy protein isolate, soy protein concentrate, soy protein (soy flour full-fat, soy flour defatted) are referred to as soy powder in the following description.

Additional soy dietary fiber is added as a main ingredient. The soy dietary fiber content is 2%˜8% of the final weight.

When processed soy material is soy milk, the water content (4) is replaced by said soy milk.

2) Thickeners: the thickener used is guar gum and can be substituted with other thickeners, or a combination of guar gum with other thickeners such as: Arabic gum, locust bean gum, corn sugar gum, pectin . . . etc. The amount of thickener used should be less than or equal to 3% of the final product weight.

3) Gelling agent: the gelling agent used is sodium alginate and can be substituted with ammonium alginate or potassium alginate. The amount of gelling agent used should be less than or equal to 4% of the final product weight.

4) Water: the amount of water used is calculated as follow:

EFPW−PSPW−TW−GAW−SFW−OIW=RWW

EFPW: Estimated Final Product Weight

PSPW: Processed Soy Product Weight

TW: Thickener Weight

GAW: Gelling Agent Weight

SFW: Soy Fiber Weight

OIW: Other Ingredient Weight

RWW: Required Water Weight

5) Firming agent: the firming agent used is calcium chloride and can be substituted with calcium lactate, calcium sulfate, or a combination. The amount of firming agent used should be less than or equal to 0.6%.

The production process of this invention:

First Step: Mixing Process

Evenly mix one of the processed soy material (or a combination of the processed soy materials) with thickener (2), gelling agent (3), soy dietary fiber, and water (4).

The mixing process in the first step can also be achieved by dissolving the thickener, gelling agent in water and mix the solution into soy powder and soy dietary fiber.

For special flavoring, various spices, flavoring agents, or mushroom powders can be first dissolved or mixed into the water and then proceed with the above step.

When the processed soy material is soy milk, water (4) and processed soy material (1) content is entirely replaced with soy milk. The first production step would be blending soy dietary fiber, thickeners, and gelling agents into the soy milk. Additional flavoring agents can be first dissolved into soy milk and proceed with the above process.

The first step can be completed manually or with a blender or a mixing machine. Manual production process is time consuming and uneconomical. To achieve the best result and quality, single screw extrusion process or twin screw extrusion process is recommended.

Second Step: Forming and Solidifying Process

Method I) Prior to extruding the mixture, blend the firming agent solution into the mixture and immediately extrude the mixture through dies. Because of the reaction speed of gelling agent with firming agent, accurate timing is very important in producing good quality final product. Twin screw extrusion process is the recommended process to best control timing and speed. When producing with twin screw extrusion method, reserve 5%˜8% of the water (4) to dissolve firming agent and inject into the mixture prior to extrusion.

If the processed soy material is soy milk, the required amount of soy milk is reduced by 3%˜6%. The equivalent amount of water is used to dissolve the firming agent to form firming solution and proceed with the same process as above.

In one preferred form, said water (e) and the processed soy product (a) comprise soy milk, produced with dry soy bean weight to water weight ratio of from about 1:2.5 to about 1:6.

Method II) Extrude the mixture through dies directly into firming solution, soak until the extruded material solidifies. The firming agent used with this method is calcium chloride and the concentration should be less than or equal to 1% of the water content in the firming solution.

Method II is a simpler production process. Depending on the shape of the die, this invention can be shaped into various forms such as strings, sheets, or other forms.

This invention can also be formed into shells for fillings or tubular form with fillings. Through co-extrusion process, this invention can be formed into various thicknesses of bars or tubs with fillings and can be cut and pressed into pillows or other forms. Co-extrusion process produces pastas with fillings and requires Method II to solidify the final product.

This invention can be prepared into different flavors without adding fat or sugar. One variation is substituting water content (4) with fruit juice, vegetable juice, or seaweed juice. This invention can also be served as dessert, salad, main course and can be steamed, boiled, stir fried, pan seared, and deep fried.

To enhance nutritional value of this invention, vitamins, calcium, magnesium, or other FDA allowed human essential minerals can be added during the first step of manufacturing process.

The production process of this invention can be further improved to raise quality and efficiency. While preferred embodiments of this invention have been disclosed for illustrative purposes, various modifications, additions and substitutions to the mixture are possible without departing from the scope and spirit of the soy-based, high moisture, high fiber, and high protein pasta without carbohydrate from grains and tubers as set forth in the accompanying claims.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth is to be interpreted as illustrative and not in a limiting sense.

1. A method for preparing a high soy protein pasta that is low in carbohydrate, comprising:
mixing (a) processed soy products, (b) soy dietary fiber, (c) thickeners, (d) gelling agents, and (e) water;
extruding the mixture through dies to form desired shapes;
hardening with a (f) firming agent to form the pasta, whereby the pasta is high in moisture content; and
adding other ingredients if needed to suit different taste and color preference.

2. The method of claim 1, wherein said processed soy product (a) comprises soy protein isolate, wherein the soy protein isolate content is approximately 30% of final product weight for a medium texture, and wherein the percentage is increased to above 30% for a harder texture and is decreased below 30%.

3. The method of claim 1, wherein said processed soy product (a) comprises soy protein concentrate, wherein the soy protein concentrate content is approximately 35% of final product weight for a medium texture, and wherein the percentage is increased to above 35% for a harder texture and the percentage is decreased to below 35% for a softer texture.

4. The method of claim 1, wherein said processed soy product (a) comprises soy protein (soy flour full-fat, soy flour defatted), wherein the soy protein content is approximately 40% of final product weight for a medium texture, and wherein the percentage is increased to above 40% for a harder texture, and the percentage is decreased to below 40% for a softer texture.

5. The method of claim 1, wherein said water (e) and the processed soy product (a) comprise soy milk, produced with dry soy bean weight to water weight ratio of from about 1:2.5 to about 1:6.

6. The method of claim 1, wherein said processed soy product (a) comprises a combination of soy protein isolate, soy protein concentrate, soy protein (soy flour full-fat, soy flour defatted), and soy milk.

7. The method of claim 1, wherein the said processed soy product (a) comprises soy protein isolate, soy protein concentrate, soy protein (soy flour full-fat, soy flour defatted), soy milk, or soy milk concentrate, further comprising the step of adding additional soy fiber, wherein the soy fiber content from about 2% to about 8% of final product weight.

8. The method of claim 1, wherein said thickener (c) comprises guar gum, wherein the guar gum content is less than or equal to about 3% of final product weight.

9. The method of claim 1, wherein said thickener comprises a mixture of guar gum with one or more other thickeners selected from the group of: Arabic gum, locust bean gum, corn sugar gum, pectin and other thickeners that will not reduce the effect of the gelling agent.

10. The method of claim 1, wherein said gelling agent (d) comprises sodium alginate wherein the sodium alginate content is less than or equal to about 6% of final product weight.

11. The method of claim 10, wherein said gelling agent comprises ammonium alginate or potassium alginate.

12. The method of claim 1, wherein the water content (e) is substantially calculated as follow:
EFPW−PSPW−TW−GAW−SFW−OIW=RWW
EFPW: Estimated Final Product Weight
PSPW: Processed Soy Product Weight
TW: Thickener Weight
GAW: Gelling Agent Weight
SFW: Soy Fiber Weight
OIW: Other Ingredient Weight
RWW: Required Water Weight

13. The method of claim 5 or claim 6, where in said soy milk content is substantially calculated as follows:
EFPW−PSPW−TW−GAW−SFW−OIW=SMW
EFPW: Estimated Final Product Weight
PSPW: Processed Soy Product Weight
TW: Thickener Weight
GAW: Gelling Agent Weight
SFW: Soy Fiber Weight
OIW: Other Ingredient Weight
SMW: Soy Milk Weight

14. The method of claim 12, wherein said water content comprises at least one item from the group of fruit juice, vegetable juice, and seaweed juice.

15. The method of claim 5 or claim 6, further comprising the step of mixing said soy milk with at least one item from the group of fruit powder or vegetable powder or seaweed powder.

16. The method of claim 12 or claim 13, further comprising the step of adding one or more ingredients to the water or soy milk, taken from the group of spices, flavoring agents, and mushroom powder.

17. The method of claim 1, wherein said firming agent (f) comprises calcium chloride, wherein the calcium chloride content is less than or equal to about 0.6% of final product weight.

18. The method of claim 17, wherein said firming agent comprises at least one item from the group of calcium lactate, calcium sulfate, and a mixture.

19. The method of claim 1, wherein the hardening process comprises the steps of injecting and mixing the firming agent solution (f) into the mixture at the final stage right before extruding the mixture through die, wherein the firming agent solution is formulated by using from about 5% to about 8% of water (e) to mix or dissolve the firming agent and when the processed soy product comprises soy milk, from about 5% to about 8% of soy milk is replaced by equal amount of firming agent solution.

20. The method of claim 1, wherein the hardening process comprises the steps of soaking the extruded mixture in firming agent solution (f) until desired firmness and formulating the firming agent solution by dissolving calcium chloride with water in which the calcium chloride weight is less than or equal to about 1% of water weight.

21. The method of claim 1, further comprising the step of extruding the pasta, whereby the pasta can be extruded into different shapes such as sheets, various diameter/thickness of spaghetti, linguine, tubes, or other forms.

22. The method of claim 1, further comprising the steps of co-extruding the pasta into various thicknesses of bars or tubes with fillings and cutting and pressing into pillows or other forms.

23. The method of claim 20, wherein the final pasta is in sheet form, further comprising the steps of adding fillings between two sheets and pressing and cutting into different shapes and soaking in the firming agent solution.

24. The method of claim 1, further comprising the step of adding an ingredient from the group of vitamins, calcium, magnesium, and other minerals approved by FDA to be added into food products.
